(19) United States
(12) Patent Application Publication
(10) Pub. No.: US 2008/0190705 A1
(43) Pub. Date: Aug. 14, 2008

(54) Announcements Indicating One Car is Waiting for Another Car in the Same Hoistway

(76) Inventors: Harry Terry, Avon, CT (US); Theresa Christy, West Hartford, CT (US); Frank Sansevero, Glastonbury, CT (US)

Correspondence Address: CARLSON GASKEY & OLDS, 400 W MAPLE STE 350, BIRMINGHAM, MI, 48009, US

(21) Appl. No.: 11/815,455

(22) PCT Filed: Feb. 4, 2005
(86) PCT No.: PCT/US2005/003798

§ 371 Date: Aug. 3, 2007

(51) Int. Cl. B66B 1/34

(52) U.S. Cl. 187/249; 187/394

(57) ABSTRACT

A pair of elevator cars (23, 24) traveling in the same hoistway (27) in response to a controller (28) may stop with the doors closed, or remain at a stop with the doors open, whenever one of the cars has to wait until another car moves out of the way before the one elevator car can proceed to finish service to its passengers. Within each cab (30) both a sign (29) and a loudspeaker (33) may present the same message to the passengers, assuring them that the operation is normal and that there is no need for alarm.

### TECHNICAL FIELD

This invention relates to an elevator system in which there is more than one car in each hoistway; a car which must wait for another car to move out of the way provides to the passengers both visual and audible indications that they will have to wait, thereby keeping the passengers comfortable and calm.

### BACKGROUND ART

There is a new trend toward having more than one elevator car in a given hoistway, thereby to increase the elevator capacity for a given amount of floor space dedicated to elevator hoistways. Regardless of the manner in which cars are assigned to respond to calls and deliver passengers to their destination floors, maximum utilization of both elevator cars invariably results in one car either being too close to or desiring to go past another car in the same hoistway. When this situation occurs, one elevator car stops without the doors opening, or remains an obviously long time at a stop with the doors open, to wait; it is important that passengers not become alarmed in any way as a result.

### DISCLOSURE OF INVENTION

Objects of the invention include: assuring passengers in an elevator car that the fact that the car has delayed at a normal stop or has stopped without the doors opening is a normal occurrence, and there is nothing wrong; providing information to prevent passengers from becoming alarmed when a car delays at a normal stop or stops without its doors open, in an elevator system in which there is more than one car in each elevator shaft; improved multi-car elevator service; and elevator service which maintains comfort and serenity among passengers even though one car must wait for another car in the hoistway to move out of the way.

According to the present invention, each elevator car of an elevator system in which there is more than one elevator car in a hoistway is provided with visual and audible messages to passengers within the car, whenever the car is delayed at a normal stop or stopped without the doors open, to assure the passengers that they are simply waiting for another elevator car to move out of the way; the messages may vary in content yet provide the correct assurance. According to the invention further, electric signage, which may be separate or part of the existing display within an elevator car, displays a message which assures passengers that there is no reason for alarm, such as “Please Wait While Other Car is Loading”, or other messages; in addition, the same message may also be presented audibly.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified, stylized side elevation view of a portion of an elevator system having a pair of elevator cars in a single hoistway, when two cars are traveling too closely to each other.

FIG. 2 is a partial, front elevation view of signage and a loudspeaker within an elevator car, according to the present invention

FIG. 3 is a simplified, stylized side elevation view of a portion of an elevator system having a pair of elevator cars in a single hoistway, when one car is waiting for an empty car to be stored in the overhead.

### MODE(S) FOR CARRYING OUT THE INVENTION

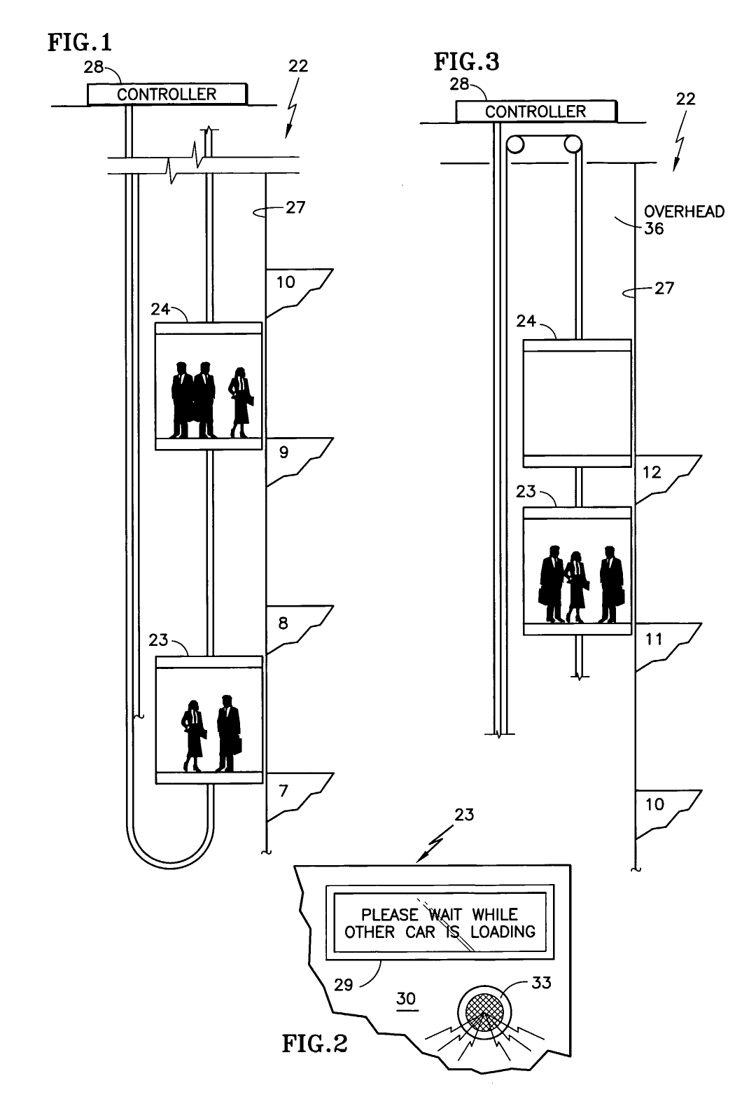

Referring to FIG. 1, an elevator system 22 includes a lower elevator car 23 and an upper elevator car 24. The cars are within the same hoistway 27 and are both shown stopped at respective floors 7 and 9. In this situation, when there is only one floor between the two elevator cars, it may be deemed unsafe for either car to move except for one or both of the cars to move in a direction away from the other car; for instance, car 24 may move upwardly, or car 23 may move downwardly. If car 23, for instance, has passengers for the eighth floor, then car 23 must wait until car 24 moves upwardly, thereby to satisfy the safety criterion. A controller 28 responds to the situation and causes car 23 to stop and wait with its doors closed.

During this time, car 23 is delayed at a regular stop to wait, and, in accordance with the invention, a visual indicator, such as a sign 29 (FIG. 2) within the cab of car 23, will display a message such as “Please Wait While Other Car is Loading” or any other suitable message that assures passengers operation is normal. At the same time, an audible device, such as a loudspeaker 33 within the cab 30, may orally present the same message to the passengers, thereby to assure them that everything is secure and safe.

The car may have been stopped with its doors open to permit entry or exit of a passenger; in such case, the invention will still present the message to account for the fact that the doors are not closing to resume to the trip. If the car is stopped by the controller where there is no call, the doors will remain closed. The message of the invention explains that situation.

Another situation is illustrated in FIG. 3 wherein car 23 is at the 11^{th} floor and car 24 is at the 12^{th} floor. Car 24 is empty and car 23 must approach the 12^{th} floor to allow its passengers to exit. Car 23 stops at the 11^{th} floor and the doors remain closed. In this situation, car 23 must wait until car 24 moves upwardly into the overhead 36 to be stored, at least until car 23 delivers its passengers and then travels downwardly away from floor 12; car 24 may remain stored during periods of light traffic.

In the situation of FIG. 3, the sign 29 and loudspeaker 33 of FIG. 2 will once again deliver a message assuring passengers that everything is normal and there is no need for alarm.

The invention may be practiced with visual indicators and audible devices of various sorts. Either a visual or an audible message may be used without the other within the purview of the invention.

1-2. (canceled)

3. An elevator system, comprising:
at least one hoistway;
at least two elevator cars traveling within said at least one hoistway;
at least one controller for controlling the operation of the elevator cars in said at least one hoistway, said controller causing each elevator car to stop or wait when further motion of the elevator car would cause the elevator car to come too close to another one of said elevator cars in said hoistway; and
a message delivering device in each of said elevator cars, said device selected from one or more of
a visual indicator which displays a visual message assuring passengers that the stop or wait is normal or
an audible device for presenting a message that the stop or wait is normal.

4. A method of operating an elevator system having at least one hoistway, at least two elevator cars traveling within said at least one hoistway, at least one controller for controlling the operation of the elevator cars in said at least one hoistway, comprising the steps of:
causing at least one of the elevator cars to stop or wait when further motion of the at least one elevator car would cause the at least one elevator car to become too close to another one of said elevator cars in said hoistway; and
presenting a message in the at least one elevator car when stopping or waiting, said message assuring passengers that the stopping or waiting is normal.
